(19) United States
(12) Patent Application Publication
(10) Pub. No.: US 2014/0129035 A1
(43) Pub. Date: May 8, 2014

(54) Excess Flow Control Valve Calibration Method

(71) Applicant: CATERPILLAR INC., Peoria, IL (US)

(72) Inventors: Matthew S. Marquette, Peoria, IL (US); Gavin D.O. Ripley, Garner, NC (US); Bryan A. Johnson, Montgomery, IL (US); Jason L. Brinkman, Peoria, IL (US); Aristoteles Rosa Neto, St. Charles, IL (US)

(73) Assignee: CATERPILLAR INC., Peoria, IL (US)

(21) Appl. No.: 13/671,399

(22) Filed: Nov. 7, 2012

(51) Int. Cl. G05D 7/06

(52) U.S. Cl. CPC G05D 7/06
USPC 700/282

(57) ABSTRACT

A computer-based method for calibrating a solenoid-controlled excess flow control valve that couples a first hydraulic circuit to a second hydraulic circuit is provided. The method includes determining a start-of-flow current at which hydraulic fluid begins to flow, closing the valve, sending an actuator command to the second hydraulic circuit, determining a first flow through the hydraulic actuator, opening the valve by setting the solenoid current to a calibration-flow current, sending the actuator command to the second hydraulic circuit, determining a second flow through the hydraulic actuator, calculating a flow difference, determining a calibration-flow valve command associated with the flow difference, determining a maximum-flow current based on the start-of-flow current, the calibration flow current, and the calibration-flow valve command, and creating a valve calibration table based on the start-of-flow current, the maximum-flow current and a valve response table.

### TECHNICAL FIELD

The present disclosure relates to valves. More particularly, the present disclosure relates to an excess flow control valve calibration method.

### BACKGROUND

Off-highway vehicles, for example wheel loaders, motor graders, excavators, and dozers are commonly used in material moving applications such as mining, road maintenance, and surface contouring. To effectively accomplish tasks associated with these applications, the vehicles are typically outfitted with steering components such as hydraulically-powered articulation joints and/or traction devices, and hydraulically powered implements such as shovels, buckets, and blades. A prime mover, for example a diesel, gasoline, or gaseous fuel-powered engine, drives dedicated steering and implement pumps that provide hydraulic power to the steering components and the implements.

The steering pump can be driven by the prime mover to pressurize fluid in response to a fluid demand from steering actuators during a steering event. When no fluid demand exists or when the fluid demand is relatively low, the steering pump may have excess capacity to pressurize fluid.

Hydraulically powered implements are typically velocity controlled based on an actuation position of an operator interface device. For example, an operator interface device such as a joystick, a pedal, or any other suitable operator interface device is movable to generate a signal indicative of a desired velocity of an associated hydraulic actuator. When an operator moves the interface device, the operator expects the hydraulic actuator to move the implement at an associated velocity. However, when multiple actuators are simultaneously operated, the hydraulic fluid flow from a single implement pump can be insufficient to move all of the actuators at their desired velocities. Situations also exist where the single implement pump is undersized and the desired velocity of a single actuator requires a fluid flow rate that exceeds the flow capacity of the single implement pump.

When the steering pump has excess capacity and the implement pump has insufficient capacity to supply a commanded/demanded flow of pressurized fluid, it may be desirable to share pressurized fluid between steering and implement circuits, and a solenoid-operated control valve may be provided therebetween for selectively allowing or blocking fluid flow between the steering circuit and the implement circuit. Calibration of this solenoid-operated control valve, at a system level, is key to the performance of this flow-sharing system, and has not yet been addressed. While methods for calibrating an electrically-controlled hydraulic valve within a hydraulic circuit having a single pump are known (e.g., U.S. Pat. No. 7,997,117), such methods are inapplicable to an electrically-controlled valve that couples multiple hydraulic circuits, each having a pump, to share excess flow.

### SUMMARY

One aspect of the present disclosure advantageously provides a computer-based method for calibrating a solenoid-controlled excess flow control valve that couples a first hydraulic circuit to a second hydraulic circuit. The method includes determining a start-of-flow current at which hydraulic fluid begins to flow from the first hydraulic circuit to the second hydraulic circuit, closing the valve by setting the solenoid current to a value less than the start-of-flow current, sending an actuator command to the second hydraulic circuit to operate a hydraulic actuator, determining a first flow through the hydraulic actuator during operation of the hydraulic actuator, opening the valve by setting the solenoid current to a calibration-flow current greater than the start-of-flow current, sending the actuator command to the second hydraulic circuit to operate the hydraulic actuator, determining a second flow through the hydraulic actuator during operation of the hydraulic actuator, calculating a flow difference by subtracting the first flow from the second flow, determining a calibration-flow valve command associated with the flow difference, determining a maximum-flow current based on the start-of-flow current, the calibration flow current, and the calibration-flow valve command, and creating a valve calibration table based on the start-of-flow current, the maximum-flow current and a valve response table.

In another aspect of the present disclosure, a controller for a vehicle that includes a solenoid-controlled excess flow control valve that couples a steering hydraulic circuit to an implement hydraulic circuit with a lift control valve coupled to a lift cylinder is provided. The controller includes a memory and a processor, coupled to the memory and the first and second hydraulic circuits, adapted to execute instructions stored in the memory to perform a method for calibrating the solenoid-controlled excess flow control valve. The instructions include determining a start-of-flow current at which hydraulic fluid begins to flow from the steering hydraulic circuit to the implement hydraulic circuit, with the excess flow control valve closed, determining a first flow through the lift cylinder during operation thereof, with the excess flow control valve partially open, determining a second flow through the lift cylinder during operation thereof, determining a valve command, associated with the partially-open excess flow control valve, based on a flow difference between the first flow and the second flow and a valve response table stored in the memory, determining a maximum-flow current based on the start-of-flow current, a current associated with the partially-open valve, and the valve command, and creating a valve calibration table based on the start-of-flow current, the maximum-flow current and the valve response table.

### BRIEF DESCRIPTION OF THE DRAWINGS

FIG. 1 presents an illustration of an exemplary vehicle;

FIG. 2 depicts a block diagram of a hydraulic system for a vehicle, according to an embodiment of the present disclosure.

FIG. 3 presents a schematic and diagrammatic illustration of a hydraulic system for a vehicle, according to an embodiment of the present disclosure;

FIGS. 4A and 4B present solenoid-controlled hydraulic valve calibration curves, according to an embodiment of the present disclosure;

FIG. 5 presents a solenoid-controlled hydraulic valve response curve, according to an embodiment of the present disclosure;

FIG. 6 presents a solenoid-controlled hydraulic valve linearization curve, according to an embodiment of the present disclosure; and

FIG. 7 depicts a flow chart presenting a method for calibrating a solenoid-controlled hydraulic valve, according to an embodiment of the present disclosure.

### DETAILED DESCRIPTION

U.S. patent application Ser. No. 12/790,402, filed on May 28, 2010, discloses a hydraulic system that shares pressurized fluid between steering and implement circuits, and is incorporated herein by reference in its entirety.

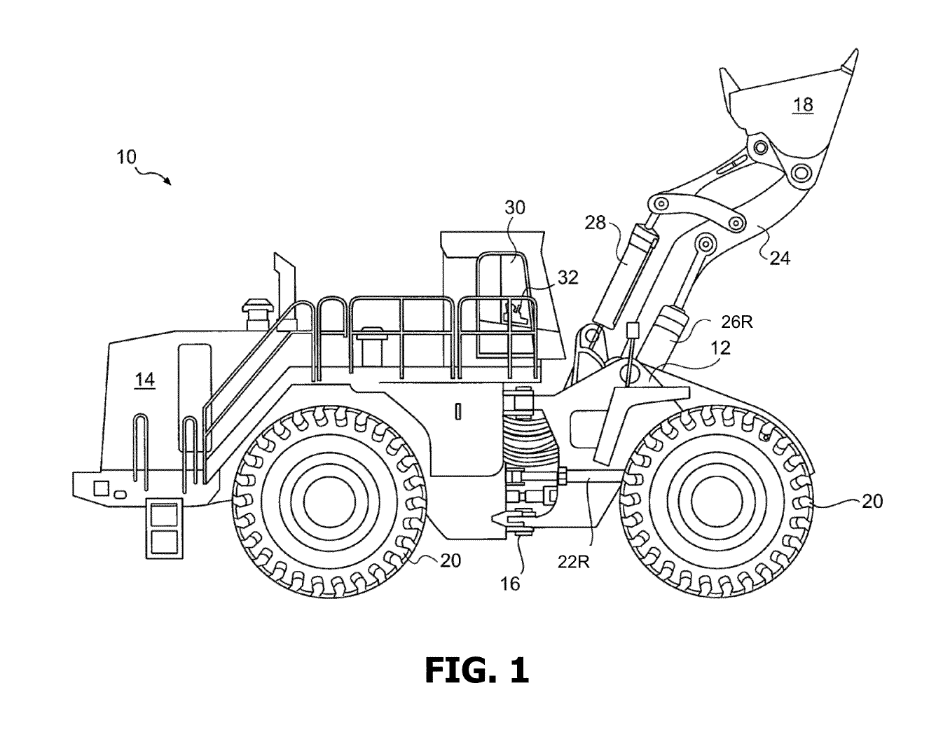

FIG. 1 illustrates an exemplary disclosed vehicle 10. Vehicle 10 may be a mobile vehicle that performs some type of operation associated with an industry such as mining, construction, farming, or any other industry known in the art. For example, vehicle 10 may be a material moving vehicle such as a wheel loader (depicted), an excavator, a backhoe, a motor grader, or any other suitable operation-performing vehicle. Vehicle 10 may include a frame 12, a power source 14 supported by frame 12, a steering component 16, and an implement 18. Steering component 16 and implement 18 may be driven by power source 14 to steer vehicle 10 and to move relative to frame 12, respectively.

Frame 12 may include any structural member or assembly of members that supports movement of vehicle 10. For example, frame 12 may embody a stationary base frame connecting power source 14 to one or more traction devices 20 (e.g., wheels) and/or to implement 18. Alternatively, frame 12 may embody a movable frame member of a linkage system.

Power source 14 may be an engine, for example, a diesel engine, a gasoline engine, a gaseous fuel-powered engine such as a natural gas engine, or any other engine apparent to one skilled in the art. Power source 14 may also embody another source of power such as a fuel cell, a power storage device, or any other source of power. Power source 14 may be supported by frame 12 and configured to produce a mechanical and/or electrical power output used to drive operation of steering component 16 and implement 18.

Steering component 16, in one embodiment, may include a centrally-located articulation joint. To affect steering of vehicle 10, a hydraulic actuator 22R located on one side of vehicle 10 may extend while a similar hydraulic actuator 22L (not visible) located on an opposite side of vehicle 10 simultaneously retracts. The paired extension and retraction of the opposing hydraulic actuators 22L, 22R may cause a forward-end of vehicle 10 to pivot about steering component 16 relative to a back-end of vehicle 10. It is contemplated that steering component 16 may alternatively or additionally include a rack and pinion mechanism, independent gear drives or motors associated with individual traction devices 20, or other steering components known in the art, if desired.

Implement 18 may embody a specialized device used in the performance of a particular task. For instance, implement 18 may embody a bucket, a blade, a shovel, a ripper, a dump bed, a propelling device, or any other task-performing device known in the art. Implement 18 may be connected to frame 12 via a linkage system 24 and movable relative to frame 12 by way of one or more hydraulic actuators. Although shown as being lifted by hydraulic actuators 26L (not visible) and 26R, and tilted by hydraulic actuator 28, it is contemplated that implement 18 may alternatively or additionally be configured to pivot, rotate, slide, swing, or move in any other way relative to frame 12, if desired.

Steering and implement control of vehicle 10 may be provided by way of an operator station 30. Operator station 30 may be supported by frame 12 and include one or more operator interface devices 32, for example, a steering wheel, single or multi-axis joysticks, switches, knobs, or other known devices that are located proximal to an operator seat. Operator interface devices 32 may be proportional-type controllers configured to generate control signals indicative of a desired position, force, velocity, and/or acceleration of hydraulic actuators 22L, 22R, 26L, 26R, and 28.

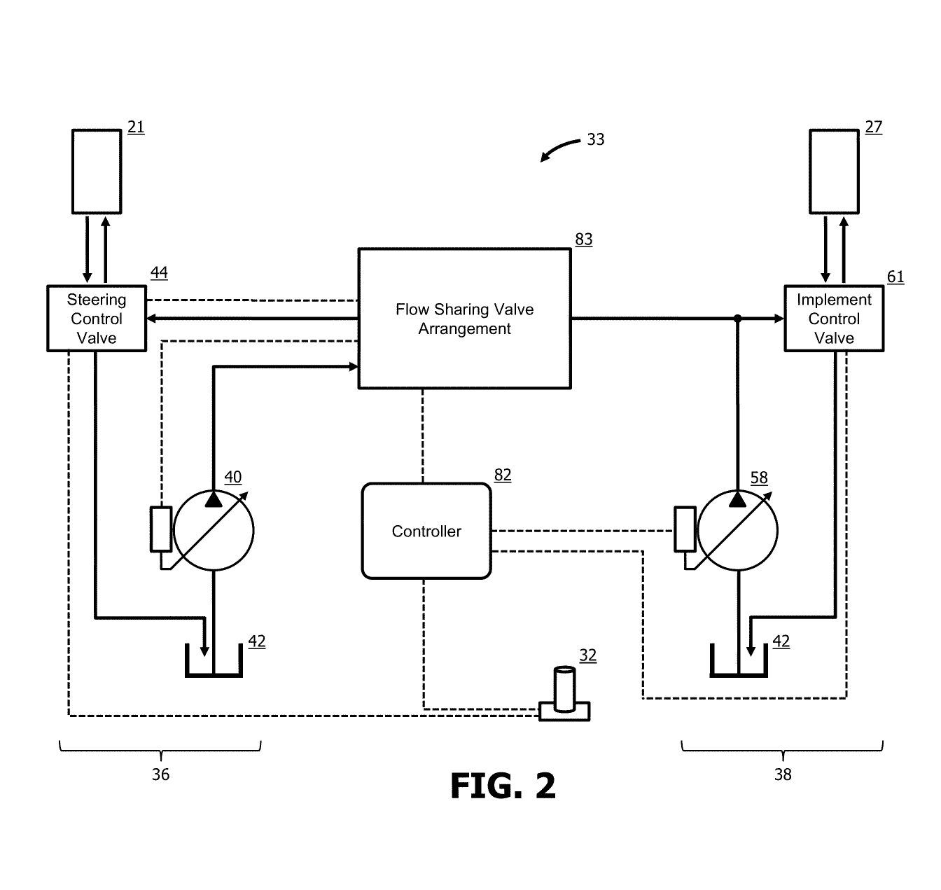

In the embodiment illustrated in FIG. 2, hydraulic system 33 may include a steering circuit 36 and an implement circuit 38. Steering circuit 36 may function to supply one or more hydraulic actuators 21 with pressurized fluid to move steering component 16 and thereby steer vehicle 10. Implement circuit 38 may function to supply one or more hydraulic actuators 27 with pressurized fluid to move implement 18 relative to frame 12.

Steering circuit 36 may include a steering pump 40 configured to draw fluid from a low-pressure reservoir 42, pressurize the fluid, and direct the pressurized fluid to the hydraulic actuator 21 by way of a steering control valve 44. Implement circuit 38 may include an implement pump 58 configured to draw fluid from low-pressure reservoir 42, pressurize the fluid, and direct the pressurized fluid to the hydraulic actuator 27 via one or more implement control valves 61, such as a tilt control valve, a lift control valve, etc.

Controller 82 may be in communication with operator interface device 32, implement pump 58, and other components of steering circuit 36 and/or implement circuit 38 to regulate operations of hydraulic system 33 in response to input from operator interface device 32 and implement pump 58. Controller 82 may include single or multiple microprocessors, field programmable gate arrays (FPGAs), digital signal processors (DSPs), and the like, volatile and non-volatile memories, electrical interfaces, etc., to control, inter alia, the operation of hydraulic system 33 in response to the signals received from operator interface device 32 and implement pump 58.

Steering circuit 36 and implement circuit 38 may be fluidly interconnected by way of a flow-sharing valve arrangement 83 that is regulated by controller 82. In particular, in some situations, the output of implement pump 58 may be insufficient to satisfy operator demands for implement movement. In these situations, flow-sharing valve arrangement 83 may be controlled to share excess pressurized fluid from steering circuit 36 with implement circuit 38. For this reason, flow-sharing valve arrangement 83 may selectively connect steering pump 40 of steering circuit 36 to implement control valve 61 of implement circuit 38.

Flow-sharing valve arrangement 83 may include a solenoid-operated hydraulic control valve to regulate fluid flow from steering circuit 36 to implement circuit 38. The solenoid-operated hydraulic control valve is an electromechanically operated valve that is controlled by an electric current provided to a solenoid. In one embodiment, the solenoid acts directly upon a valve element to open and close the control valve. In another embodiment, the solenoid acts upon a pilot valve that provides control fluid to a larger, pneumatically-operated main control valve. In either case, the amount of current provided to the solenoid must be correlated to the amount of fluid flow through the control valve, which is typically done through a calibration process. Once the solenoid-operated hydraulic control valve has been calibrated, controller 82 determines the amount of excess flow that should be allowed to flow from steering circuit 36 to implement circuit 38, determines the current necessary to provide the excess flow, and then sets the current of the solenoid to open the control valve.

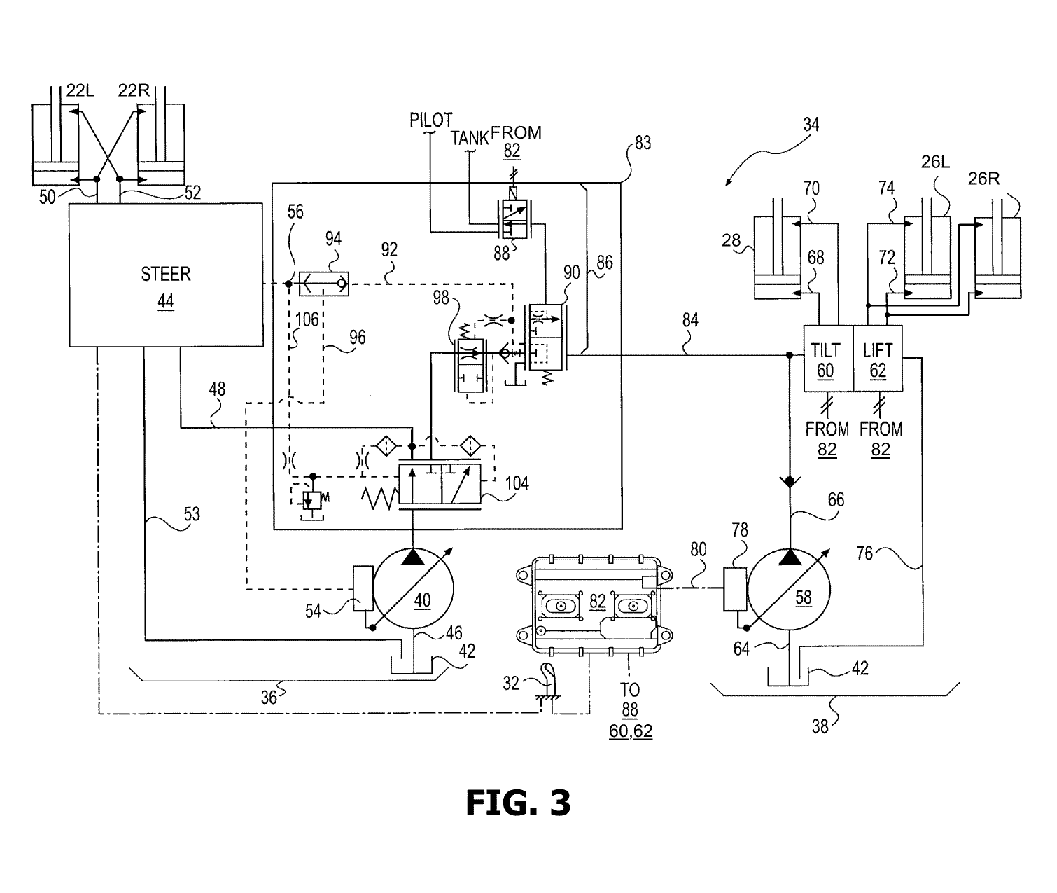

In the embodiment illustrated in FIG. 3, hydraulic system 34 may include a steering circuit 36 and an implement circuit 38. Steering circuit 36 may function to supply hydraulic actuators 22L, 22R with pressurized fluid to move steering component 16 and thereby steer vehicle 10. Implement circuit 38 may function to supply hydraulic actuators 26L, 26R and 28 with pressurized fluid to move implement 18 relative to frame 12.

Steering circuit 36 may include a steering pump 40 configured to draw fluid from a low-pressure reservoir 42, pressurize the fluid, and direct the pressurized fluid to hydraulic actuators 22L, 22R by way of a steering control valve 44. Steering pump 40 may be connected to low-pressure reservoir 42 via a tank passage 46 and to steering control valve 44 via a supply passage 48. Steering control valve 44 may be connected to hydraulic actuators 22L, 22R by way of first and second passages 50, 52, respectively, and to low-pressure reservoir 42 by way of a drain passage 53.

Steering pump 40 may have variable displacement and be load-sense controlled. That is, steering pump 40 may include a stroke-adjusting mechanism 54, for example a swashplate or spill valve, a position of which is selectively adjusted based on a sensed load of steering circuit 36 to thereby vary an output of (i.e., a rate at which fluid is pressurized by) steering pump 40. In one embodiment, a load-sense passage 56 may direct a pressure signal from a location downstream of steering control valve 44 to stroke-adjusting mechanism 54. Based on a value of the signal (i.e., based on a pressure of signal fluid within load-sense passage 56) directed to stroke-adjusting mechanism 54, the position of stroke-adjusting mechanism 54 may change to either increase or decrease the output of steering pump 40. For the purposes of this disclosure, a load-sense controlled pump may be considered a pump that is hydro-mechanically controlled to vary a displacement based on a load of the circuit receiving fluid from the pump, a pilot signal indicative of the load being directed to a displacement mechanism of the pump.

Steering control valve 44 may selectively connect first and second passages 50, 52 to supply and drain passages 48, 53 to steer vehicle 10. For example, to turn vehicle 10 to the right, steering control valve 44 may connect first passage 50 to supply passage 48, while simultaneously connecting second passage 52 to drain passage 53. This operation may cause the left hydraulic actuator 22L (as viewed in FIG. 2) to extend and the right hydraulic actuator 22R to retract, thereby pivoting the front end of vehicle 10 clockwise (when viewed from above) about steering component 16. To turn vehicle 10 to the left, steering control valve 44 may connect first passage 50 to drain passage 53, while simultaneously connecting second passage 52 to supply passage 48. This operation may cause the right hydraulic actuator 22R to extend and the left hydraulic actuator 22L to retract, thereby pivoting the front end of vehicle 10 counterclockwise about steering component 16.

Implement circuit 38 may include an implement pump 58 configured to draw fluid from low-pressure reservoir 42, pressurize the fluid, and direct the pressurized fluid to hydraulic actuators 26L, 26R by way of a lift control valve 62, and to hydraulic actuator 28 by way of a tilt control valve 60. Implement pump 58 may be connected to low-pressure reservoir 42 by way of a tank passage 64 and to tilt and lift control valves 60, 62 by way of a supply passage 66. Tilt control valve 60 may be connected to hydraulic actuator 28 by way of head-end passage 68 and rod-end passage 70, while lift control valve 62 may be connected to hydraulic actuators 26L, 26R by way of head-end passages 72 and rod-end passages 74. Tilt and lift control valves 60, 62 may be connected to low-pressure reservoir 42 by way of a drain passage 76.

Implement pump 58 may have variable displacement and be electro-hydraulically (E/H) controlled. That is, implement pump 58 may include a stroke-adjusting mechanism 78, for example a swashplate or spill valve, a position of which is selectively adjusted based on an electronic control signal 80 produced by a controller 82 to thereby vary an output (i.e., a flow rate) of implement pump 58. In one embodiment, electronic control signal 80 may be related (e.g., proportional) to a command received from operator interface device 32 and correspond to a demanded position, force, velocity, and/or acceleration of hydraulic actuators 26L, 26R, 28. Based on a value of electronic control signal 80 directed to stroke-adjusting mechanism 78, the position of stroke-adjusting mechanism 78 may change to either increase or decrease the output of implement pump 58, regardless of an immediate pressure within implement circuit 38. For the purposes of this disclosure, an E/H pump may be considered a pump that is electro-hydraulically controlled to vary a displacement based on an electronic signal directed to the pump's displacement mechanism.

Tilt and lift control valves 60, 62 may selectively connect head-end passages 68, 72 and rod-end passages 70, 74 to supply passage 66 and drain passage 76, respectively, to move implement 18. For example, to dump and lift implement 18, tilt and lift control valves 60, 62 may connect head-end passages 68, 72 to supply passage 66, while simultaneously connecting rod-end passages 70, 74 to drain passage 76. This operation may cause hydraulic actuators 26L, 26R, 28 to extend. To rack back and lower implement 18, tilt and lift control valves 60, 62 may connect head-end passages 68, 72 to drain passage 76, while simultaneously connecting rod-end passages 70, 74 to supply passage 66. This operation may cause hydraulic actuators 26L, 26R, 28 to retract. It should be noted that, although hydraulic actuators 26L, 26R and 28 have been described as extending and retracting simultaneously, the extensions and retractions of hydraulic actuators 26L, 26R, 28 may be performed at different times and/or in opposition to each other, if desired.

Controller 82 may be in communication with operator interface device 32, implement pump 58, and other components of steering circuit 36 and/or implement circuit 38 to regulate operations of hydraulic system 34 in response to input from operator interface device 32 and implement pump 58. Controller 82 may embody a single or multiple microprocessors, field programmable gate arrays (FPGAs), digital signal processors (DSPs), etc. that include a means for controlling an operation of hydraulic system 34 in response to the signals received from operator interface device 32 and implement pump 58. Numerous commercially available microprocessors can be configured to perform the functions of controller 82. It should be appreciated that controller 82 could readily embody a microprocessor separate from that controlling other non-hydraulic related power system functions, or that controller 82 could be integral with a general power system microprocessor and be capable of controlling numerous power system functions and modes of operation. If separate from the general power system microprocessor, controller 82 may communicate with the general power system microprocessor via datalinks or other methods. Various other known circuits may be associated with controller 82, including power supply circuitry, signal-conditioning circuitry, actuator driver circuitry (i.e., circuitry powering solenoids, motors, or piezo actuators), and communication circuitry.

Steering circuit 36 and implement circuit 38 may be fluidly interconnected by way of a flow-sharing valve arrangement 83 that is regulated by controller 82. In particular, in some situations, the output of implement pump 58 may be insufficient to satisfy operator demands for implement movement. In these situations, flow-sharing valve arrangement 83 may be controlled to share excess pressurized fluid from steering circuit 36 with implement circuit 38. For this reason, flow-sharing valve arrangement 83 may include a supplemental supply passage 84 that selectively connects steering pump 40 of steering circuit 36 to supply passage 66 and/or tilt and lift control valves 60, 62 of implement circuit 38.

Flow-sharing valve arrangement 83 may also include a solenoid-operated hydraulic control valve 86 associated with supplemental supply passage 84 to regulate fluid flow from steering circuit 36 to implement circuit 38. Control valve 86 may include a solenoid-operated element 88 in communication with controller 82 and fluidly connected to a pilot-operated element 90. Solenoid-operated element 88 may be a proportional type of element that is selectively energized by controller 82 to move to any position between a first position at which an end of pilot-operated element 90 is exposed to pressurized pilot fluid, and a second position (depicted) at which the pressurized fluid acting on the end of pilot-operated element 90 is relieved, e.g., connected to low-pressure reservoir 42. Pilot-operated element 90 may be moved by pilot fluid passing through solenoid-operated element 88 against a spring bias between a first or flow-passing position and a second or flow-blocking position (depicted). When pilot-operated element 90 is in the first position, pressurized fluid from steering circuit 36 may flow to implement circuit 38 via supplemental supply passage 84. When pilot-operated element 90 is in the second position, fluid flow through supplemental supply passage 84 may be inhibited by pilot-operated element 90. The pilot fluid passing through solenoid-operated element 88 to pilot-operated element 90 may be provided by any pump of vehicle 10, for example by implement pump 58, by steering pump 40, and/or by another pump.

Movement of pilot-operated element 90 between the first and second positions may have an effect on signal generation within a load-sense passage 92. In particular, when pilot-operated element 90 is in the first position, fluid pressure within load-sense passage 92 may be have a value corresponding to a load of implement circuit 38 (i.e., the pressure of fluid within load-sense passage 92 may be substantially equal to a pressure within supply passage 66 and/or tilt and lift control valves 60, 62). When pilot-operated element 90 is in the second position (depicted), the pressure of fluid within load-sense passage 92 may have a value corresponding to a pressure within low-pressure reservoir 42 (i.e., pilot-operated element 90 may connect load-sense passage 92 to low-pressure reservoir 42 when in the second position).

A resolver 94 may selectively allow the higher-pressure signal from load-sense passages 56 and 92 to control the displacement of steering pump 40. Specifically, resolver 94 may embody a two-position shuttle valve that is movable in response to fluid pressure between a first position (depicted) at which the signal from load-sense passage 56 is fluidly communicated with stroke-adjusting mechanism 54, and a second position at which the signal from load-sense passage 92 is fluidly communicated with stroke-adjusting mechanism 54. The shuttle valve of resolver 94 may be moved to the first position when a pressure of load-sense passage 56 is greater than the pressure of load-sense passage 92, and vice versa. Resolver 94 may be fluidly connected to stroke-adjusting mechanism 54 by way of a load-sense passage 96.

A pressure-compensator 98 may be disposed within supplemental supply passage 84, at a location upstream of control valve 86. Pressure compensator 98 may include a spring-biased valve element that is movable between a first position (depicted) at which fluid in supplemental supply passage 84 is allowed to flow through pressure compensator 98 to control valve 86, and a second position at which fluid flow through pressure compensator 98 is inhibited by pressure compensator 98. A restricted passage at one end of pressure compensator 98 may allow pilot fluid from load-sense passage 92 to join a spring bias in moving pressure compensator 98 toward the first position. A pilot passage at an opposing end of pressure compensator 98 may allow a pilot pressure signal from a location between pressure compensator 98 and control valve 86 to urge pressure compensator 98 against the spring bias toward the second position. In this configuration, pressure-compensator 98 may function to maintain a desired pressure drop across pilot-operated element 90, the desired pressure drop coupled with a known position of pilot-operated element 90 providing for a desired flow rate of fluid from steering circuit 36 to implement circuit 38. In this manner, responsiveness and control of implement circuit 38 may be maintained, even during flow sharing.

Throughout operation of hydraulic system 34, flow priority may be provided to steering circuit 36. For this purpose, a priority valve 104 may be disposed between steering pump 40 and supplemental supply passage 84 and operational to allow only excess fluid from steering pump 40 (i.e., fluid not demanded, required, or consumed by steering control valve 44) to flow into supplemental supply passage 84. Priority valve 104 may be pilot-operated and spring-biased to move between a first position (depicted) at which all flow from steering pump 40 passes to steering control valve 44, and a second position at which all flow from steering pump 40 passes through supplemental supply passage 84 to tilt and lift control valves 60, 62. It should be noted that, although priority valve 104 is depicted in a discrete position, one skilled in the art will recognize that priority valve 104 may be infinitely variable and moved to any position between the first and second positions to thereby proportionally split the flow from steering pump 40 between steering control valve 44 and supplemental supply passage 84.

A first pilot passage 106 may be fluidly connected to direct fluid from load-sense passage 56 to a first end of priority valve 104 to join a spring bias in urging priority valve 104 toward the first position. In one exemplary embodiment, a restricted orifice may be positioned within and a pressure relief valve may be associated with first pilot passage 106, if desired, to help reduce instabilities and pressure spikes within steering circuit 36. A second pilot passage may be fluidly connected to direct pressurized fluid from a location downstream of priority valve 104 to a second end of priority valve 104 to urge priority valve 104 against the spring bias toward the second position. A filter may be disposed within second pilot passage, if desired. An optional third pilot passage may be fluidly connected to direct pressurized fluid from a location downstream of priority valve 104 through a filter and a restricted orifice to the first end of priority valve 104. With this configuration, third pilot passage may function to affect a response and/or stability of priority valve 104.

### INDUSTRIAL APPLICABILITY

The hydraulic systems described above provide for the sharing of pressurized fluid from a steering circuit to an implement circuit, through an excess hydraulic flow control valve, after the implement pump has reached a threshold or maximum displacement position. Accordingly, the disclosed hydraulic valve calibration method is applicable to any vehicle having a steering hydraulic circuit and implement hydraulic circuit that are coupled by an excess hydraulic flow control valve.

In one mode of operation, steering of vehicle 10 may be occurring, and implement 18 may be requested to move at a rate that exceeds the capacity of implement pump 58.

In response to this request or, alternatively, in response to the stroke-adjustment mechanism for implement pump 58 moving to the maximum displacement position after receipt of the request, controller 82 determines how much excess flow should be provided from steering circuit 36, through the control valve of flow-sharing valve arrangement 83, to implement circuit 38 in order to accommodate the rate of movement of implement 18. Once the desired excess flow is determined, e.g., in liters per minute (lpm), controller 82 determines the amount of current to be provided to the solenoid, using, for example, a valve calibration map or table, and then sets the solenoid current accordingly. In a direct-acting solenoid-operated hydraulic control valve, the solenoid acts directly upon the valve element to open the control valve. In a pilot-operated hydraulic control valve arrangement, the solenoid acts upon a pilot valve, which provides control fluid to the pneumatically-operated control valve.

For example, in the embodiment depicted in FIG. 3, solenoid-operated element 88 of control valve 86 may be energized, by controller 82, to move to a desired flow-passing position. When solenoid-operated element 88 moves to the desired flow-passing position, pilot fluid may be directed to move pilot-operated element 90 a desired distance toward its flow-passing position, thereby allowing fluid within supplemental supply passage 84 to flow through pilot-operated element 90 at a desired rate. At this point in time, if steering pump 40 has excess capacity (i.e., if steering pump 40 can pressurize fluid at a rate greater than demanded or consumed by steering control valve 44), a pressure within supply passage 48 and second pilot passage may be sufficient to urge priority valve 104 a distance toward the second position to pass some of the fluid pressurized by steering pump 40 to supplemental supply passage 84. The distance that priority valve 104 moves toward the second position may be dependent upon the amount of excess capacity of steering pump 40. For example, as steering control valve 44 demands or consumes less fluid from steering pump 40, priority valve 104 may be moved further toward the second position because the fluid pressure within second pilot passage may increase relative to the fluid pressure within first pilot passage 106. As pilot-operated element 90 moves toward its flow-passing position, the signal within load-sense passage 92 may be generated and directed to resolver 94. Depending on which of the signals from load-sense passages 56 and 92 has the greater value (i.e., the greater pressure), stroke-adjustment mechanism 54 may adjust the stroke of steering pump 40 based on a demand of steering circuit 36 or implement circuit 38. Thus, the higher demand for fluid may drive operation of steering pump 40 such that all demands of steering circuit 36 and implement circuit 38 may be satisfied.

In another mode of operation, steering of vehicle 10 may not be occurring, and implement 18 may be requested to move at a rate that exceeds the capacity of implement pump 58.

In response to this request or, alternatively, in response to the stroke-adjustment mechanism for implement pump 58 moving to the maximum displacement position after receipt of the request, controller 82 determines how much excess flow should be provided from steering circuit 36, through the control valve of flow-sharing valve arrangement 83, to implement circuit 38 in order to accommodate the rate of movement of implement 18. Once the desired excess flow is determined, e.g., in liters per minute (lpm), controller 82 determines the amount of current to be provided to the solenoid, using, for example, the valve calibration map or table, and then sets the solenoid current accordingly. As noted above, in a direct-acting solenoid-operated hydraulic control valve, the solenoid acts directly upon the valve element to open the control valve, while in a pilot-operated hydraulic control valve arrangement, the solenoid acts upon a pilot valve, which provides control fluid to the pneumatically-operated control valve.

For example, in the embodiment depicted in FIG. 3, solenoid-operated element 88 of control valve 86 may be energized, by controller 82, to move to a desired flow position. When solenoid-operated 88 moves to the desired flow position, pilot fluid may be directed to move pilot-operated element 90 a desired distance toward its flow position, thereby allowing a desired amount of fluid within supplemental supply passage 84 to flow through pilot-operated element 90. Because steering may not be occurring at this time, the signal within load-sense passage 56 may be small or nonexistent and steering pump 40 may have excess capacity, all of which may be shared with implement circuit 38. Accordingly, a pressure within supply passage 48 and second pilot passage may be sufficient to overcome the pressure signal of load-sense passage 56 and the spring bias of priority valve 104 to urge priority valve 104 all the way to its second position and pass all of the pressurized fluid from steering pump 40 to supplemental supply passage 84. As pilot-operated element 90 moves toward its flow position, the signal within load-sense passage 92 may be generated and directed to resolver 94. Because no steering may be occurring during this mode of operation, the value of the signal from load-sense passage 56 may be very low or non-existent. Accordingly, the signal from load-sense passage 92 may have the greater value (i.e., the greater pressure), and stroke-adjustment mechanism 54 may adjust the stroke of steering pump 40 based on a demand of only implement circuit 38.

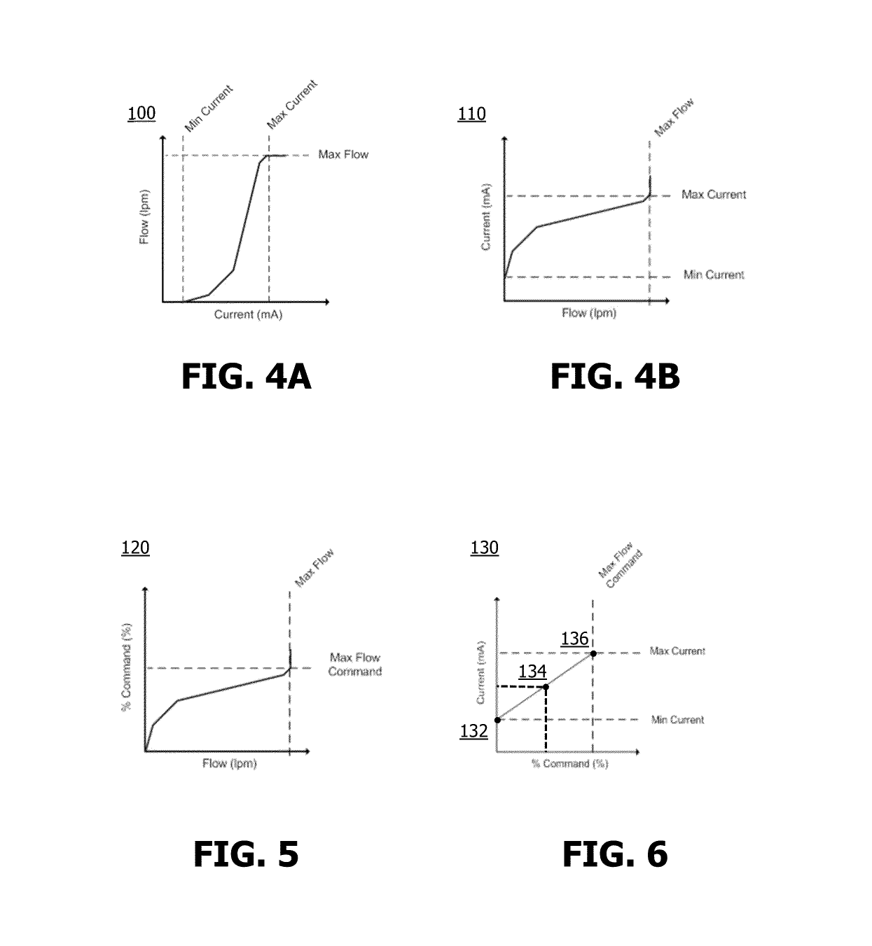

FIGS. 4A and 4B present solenoid-controlled hydraulic valve response curves, according to an embodiment of the present disclosure.

Valve response curve 100 presents valve flow (lpm) as a function of solenoid current (mA) applied to a solenoid-controlled valve, while valve response curve 110 presents the inverse, i.e., solenoid current required (mA) as a function of the desired valve flow (lpm). Valve response data are typically stored as data pairs within a map or table in a non-volatile memory of controller 82. As discussed above, operator input device 32 may request implement 18 to move at a rate that exceeds the capacity of implement pump 58. In response, controller 82 may determine how much excess flow should be provided from steering circuit 36, through the control valve of flow-sharing valve arrangement 83, to implement circuit 38 in order to accommodate the desired rate of movement of implement 18.

In one example, controller 82 may determine that the signal received from operator interface device 32 requires a hydraulic flow through actuator 27 of 304 lpm, which exceeds a maximum flow of 254 lpm that can be provided by implement pump 58. Controller 82 then determines that an additional flow of 50 lpm is needed from steering circuit 36 to accommodate the requested rate of movement, accesses the valve response data to determine the solenoid current associated with 50 lpm, commands implement pump 58 to upstroke to its maximum flow of 254 lpm, and sets the current to the solenoid-controlled hydraulic control valve within flow-sharing valve arrangement 83 accordingly. In other examples, for a requested flow of 304 lpm, controller 82 may command implement pump 58 to upstroke to about 80% of its maximum flow (204 lpm), but increase the excess flow from steering circuit 36 (100 lpm), controller 82 may command implement pump 58 to upstroke to about 60% of its maximum flow (152 lpm), but increase the excess flow from steering circuit 36 (152 lpm), etc.

In one embodiment of the valve response table depicted below, 255 flow-current data pairs are provided, the flow values ranging from zero to 254 lpm and the current values ranging from 0 mA to 1200 mA; other embodiments of the valve response table are also contemplated.

Valve Response Table

| Flow (lpm) | Current (mA) |
|---|---|
| 0 | 0 |
| 0.1 | 600 |
| . . . | . . . |
| 60 | 900 |
| . . . | . . . |
| 254 | 1200 |

Due to the hydraulic coupling of steering circuit 36 and implement circuit 38, calibration of the solenoid-controlled hydraulic control valve within flow-sharing valve arrangement 83 is critical to ensure that the current provided to the solenoid by controller 82 results in the desired flow through the excess flow control valve. Implement pump 58 always provides some amount of flow into implement circuit 38, which skews the results of known calibration techniques rendering them unsuitable for an excess flow control valve.

FIG. 5 presents a standard hydraulic valve linearization curve, while FIG. 6 presents a solenoid-controlled hydraulic valve calibration curve, according to an embodiment of the present disclosure.

Due to the fundamentally linear nature of the response of the solenoid-controlled hydraulic control valve within flow-sharing valve arrangement 83, valve response curve 110, and its associated map or data table, can be constructed by composing a standard hydraulic valve linearization curve 120, in which the flow (lpm) through the valve (input) is associated with a “% command” (output) (FIG. 5), with a solenoid-controlled hydraulic valve calibration curve 130, in which “% command” (input) is associated with solenoid current (mA) (output) (FIG. 6). The “% command” is a value between zero and 100, and represents the percentage of stem displacement shift between the cracking point and the maximum displacement point of the valve. Importantly, this construction can be applied to both direct-acting and pilot-based solenoid-controlled hydraulic control valves.

In one embodiment, the standard hydraulic valve linearization curve associates flow through the valve (lpm) with valve spool displacement (mm), and an additional curve associates valve spool displacement (mm) with “% command.” Again, due to the linear nature of the response of the solenoid-controlled hydraulic control valve, these curves can also be composed to form the standard hydraulic valve linearization curve 120. These curves are typically stored as data pairs within maps or tables in a non-volatile memory of controller 82.

In order to calibrate the solenoid-controlled hydraulic control valve within flow-sharing valve arrangement 83, the hydraulic valve calibration curve 130 is determined during operation of steering circuit 36 and implement circuit 38. In one embodiment, the standard hydraulic valve linearization curve 120 is composed with the hydraulic valve calibration curve 130 to form valve response curve 110. In another embodiment, the standard hydraulic valve linearization curve 120 and the hydraulic valve calibration curve 130 are not composed, and are simply consulted consecutively. Valve calibration curve 130, standard hydraulic valve linearization curve 120 and valve response curve 110 are typically expressed as discrete maps or data tables, rather than continuous functions, which may be preferred. Embodiments of a valve linearization map and a valve calibration map are presented below.

| | |
|---|---|
| Valve Linearization Map | Valve Calibration Map |

| Flow (lpm) | % Command | % Command | Current (mA) |
|---|---|---|---|
| 0 | 0 | 0 | 0 |
| . . . | . . . | 0.1 | 600 |
| 60 | 50 | . . . | . . . |
| . . . | . . . | 50 | 900 |
| 254 | 100 | . . . | . . . |
| | | 100 | 1200 |

Generally, valve calibration curve 130 may be assumed to be linear and fully characterized by two data points, i.e., the start-of-flow solenoid current 132 and the maximum-flow solenoid current 136. The start-of-flow solenoid current 132 is associated with a “% command” of slightly greater than zero, in which the valve is opened just enough to allow the flow to start, while the maximum-flow solenoid current 136 is associated with a “% command” of 100, in which the flow is maximum. Because implement pump 58 is always providing flow to implement circuit 38, and due to the inflection points within the standard hydraulic valve response curve 110, determining the maximum-flow solenoid current 136 directly provides unsatisfactory calibration data. Advantageously, determining the start-of-flow solenoid current 132 and a calibration-flow solenoid current 134, proximate to the inflection point within the standard hydraulic valve response curve 110, and then calculating the maximum-flow solenoid current 136 by linear extrapolation, provides excellent calibration data.

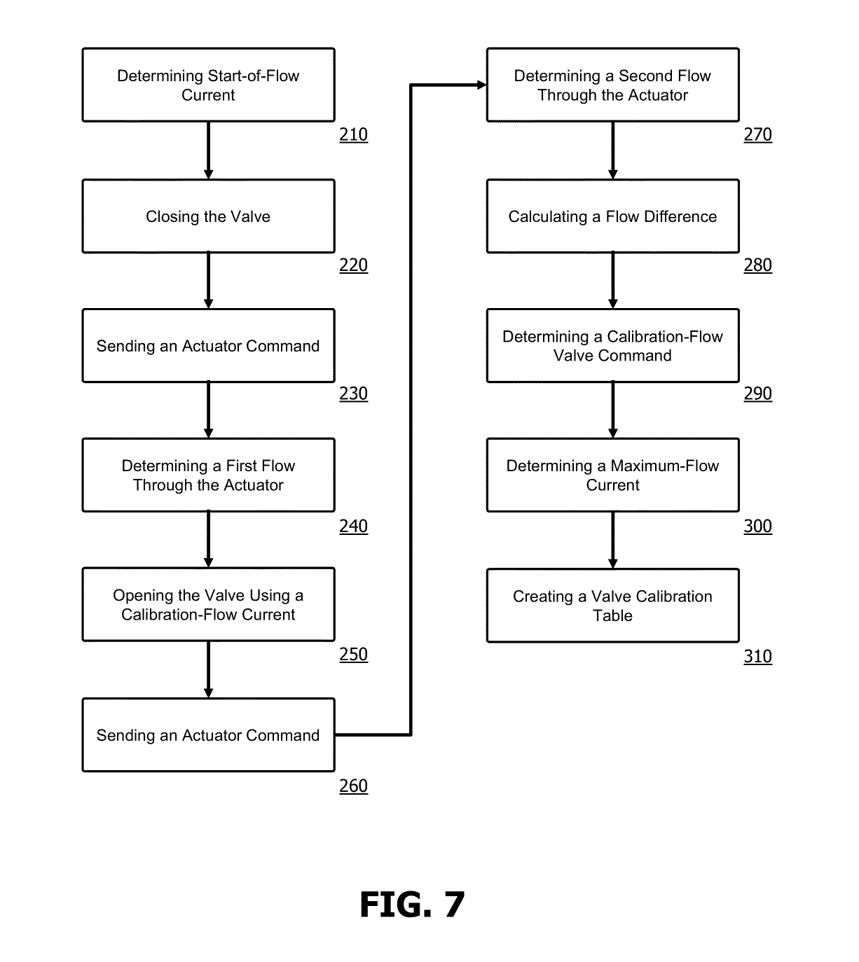

FIG. 7 depicts a flow chart presenting a method for calibrating a solenoid-controlled hydraulic valve, according to an embodiment of the present disclosure. Method 200 is a computer-based method for calibrating a solenoid-controlled excess flow control valve, such as control valve 86, that couples a first hydraulic circuit, such as steering circuit 36, to a second hydraulic circuit, such as implement circuit 38.

Controller 82 determines (210) a start-of-flow current at which hydraulic fluid begins to flow from the first hydraulic circuit 36 to the second hydraulic circuit 38. In one embodiment, the start-of-flow current may be determined by setting pump 40 within the first hydraulic circuit 36 to an initial displacement by closing the excess flow control valve and removing any steering input, setting pump 58 within the second hydraulic circuit 38 to an initial displacement, setting the solenoid current to the control valve 86 to a predetermined current value and then increasing the solenoid current to control valve 86 according to a current profile that includes a plurality of discrete current values. For each current value, controller 82 may acquire measurements from a pressure sensor coupled to the first hydraulic circuit 36, compare each pressure measurement to a predetermined pressure value, and set the start-of-flow current to the current value associated with the first measured pressure that exceeds the predetermined pressure value. In one embodiment, the margin pressure established within the first hydraulic circuit 36 may be about 2100 kPa+−100 kPa above the reservoir or tank pressure, the margin pressure established within the second hydraulic circuit 38 may be about 2500 kPa+−50 kPa above the reservoir or tank pressure, the predetermined current value may be about 400 mA, the current profile may have a ramp rate of between about 25 mA/s and about 200 mA/s, and the predetermined pressure value may be between about 200 kPa and about 1000 kPa.

Controller 82 closes (220) the excess flow control valve 86 by setting the solenoid current to a value less than the start-of-flow current.

Controller 82 sends (230) an actuator command to the second hydraulic circuit 38 to operate a hydraulic actuator. For example, the hydraulic actuator could be a single lift or tile cylinder, multiple lift or tilt cylinders, etc. In one embodiment, controller 82 sends the actuator command to implement control valve 61 in order to operate hydraulic actuator 27, which may be a single hydraulic lift cylinder, while in another embodiment, controller 82 sends the actuator command to lift control valve 62 in order to operate hydraulic lift cylinders 26L, 26R.

Controller 82 determines (240) a first flow through the hydraulic actuator during operation of the hydraulic actuator. In the embodiments discussed above, the hydraulic lift cylinders 26L, 26R, 27 have a cross-sectional area and a length, and controller 82 determines the first flow by determining a first velocity of the hydraulic lift cylinder and then multiplying the first velocity with the area of the hydraulic lift cylinder. The first velocity of the hydraulic lift cylinder may be determined by measuring a time required for the hydraulic lift cylinder to pass through a distance, determining an increase in the length of the hydraulic cylinder based on the distance, and dividing the hydraulic cylinder length increase by the time. Controller 82 may determine the distance based on data received from a rotation sensor mechanically coupled to the hydraulic cylinder. Other methods for determining the flow through hydraulic lift cylinders or other hydraulic actuators, using various sensors such as, for example, flow sensors, optical sensors, etc., are also contemplated by the present disclosure.

In one embodiment, controller 82 then returns the hydraulic actuator to the initial or pre-operation position, while in another embodiment, the operator returns the hydraulic actuator to the initial or pre-operation position using operator interface device 32.

Controller 82 opens (250) the excess flow control valve 86 by setting the solenoid current to a calibration-flow current greater than the start-of-flow current.

Controller 82 sends (260) the actuator command to the second hydraulic circuit 38 to operate the hydraulic actuator. In one embodiment, controller 82 sends the actuator command to implement control valve 61 in order to operate hydraulic actuator 27, while in another embodiment, controller 82 sends the actuator command to lift control valve 62 in order to operate hydraulic actuators 26L, 26R.

Controller 82 determines (270) a second flow through the hydraulic actuator during operation of the hydraulic actuator. In the embodiments discussed above, the hydraulic lift cylinders 26L, 26R, 27 have a cross-sectional area and a length, and controller 82 determines the second flow by determining a second velocity of the hydraulic lift cylinder and then multiplying the second velocity with the area of the hydraulic lift cylinder. The second velocity of the hydraulic lift cylinder may be determined by measuring a time required for the hydraulic lift cylinder to pass through a distance, determining an increase in the length of the hydraulic cylinder based on the distance, and dividing the hydraulic cylinder length increase by the time. As described above, controller 82 may determine the distance based on data received from a rotation sensor mechanically coupled to the hydraulic cylinder.

Controller 82 calculates (280) a flow difference by subtracting the first flow from the second flow.

Controller 82 determines (290) a calibration-flow valve command associated with the flow difference. In one embodiment, controller 82 determines the calibration-flow valve command associated with the flow difference by searching a valve linearization table, stored in the memory, for a valve command associated with the flow difference. For example, referring to the valve linearization table depicted above, a flow difference of 60 lpm is associated with a % command of 50%. Interpolation of table data is also contemplated in certain embodiments.

Controller 82 determines (300) a maximum-flow current based on the start-of-flow current, the calibration-flow current, and the calibration-flow valve command. In one embodiment, controller 82 determines the maximum-flow current by associating the start-of-flow current with a start-of-flow valve command of slightly above 0%, associating the calibration-flow current with the calibration-flow valve command, associating the maximum-flow current with a maximum-flow valve command of 100%, and solving for the maximum-flow current by linearly extrapolating a line defined by the start-of-flow current and valve command values, and the calibration-flow current and valve command values. For example, for a start-of-flow current of 600 mA, a calibration-flow current of 900 mA, and a calibration-flow command of 50%, the maximum-flow current is calculated to be 1200 mA. In alternative embodiments, two or more calibration-flow current and calibration-flow valve command data pairs are determined, and the maximum-flow current is calculated using known curve-fitting routines.

Controller 82 creates (310) a valve calibration table based on the start-of-flow current and valve command values, and the maximum-flow current and valve command values. In one embodiment, the valve calibration table includes two data pairs, i.e., the start-of-flow current and valve command values, and the maximum-flow current and valve command values. In alternative embodiments, the valve calibration table may be populated with one or more additional current and valve command values, which are determined based on the start-of-flow current and valve command values, and the maximum-flow current and valve command values.

In a further embodiment, a valve response table can be created by composing the valve linearization table and the valve calibration table.

The many features and advantages of this disclosure are apparent from the detailed specification, and, thus, it is intended by the appended claims to cover all such features and advantages which fall within its true spirit and scope. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of this disclosure.

What is claimed is:

1. A computer-based method for calibrating a solenoid-controlled excess flow control valve that couples a first hydraulic circuit to a second hydraulic circuit, the method comprising:
determining a start-of-flow current at which hydraulic fluid begins to flow from the first hydraulic circuit to the second hydraulic circuit;
closing the valve by setting the solenoid current to a value less than the start-of-flow current;
sending an actuator command to the second hydraulic circuit to operate a hydraulic actuator;
determining a first flow through the hydraulic actuator during operation of the hydraulic actuator;
opening the valve by setting the solenoid current to a calibration-flow current greater than the start-of-flow current;
sending the actuator command to the second hydraulic circuit to operate the hydraulic actuator;
determining a second flow through the hydraulic actuator during operation of the hydraulic actuator;
calculating a flow difference by subtracting the first flow from the second flow;
determining a calibration-flow valve command associated with the flow difference;
determining a maximum-flow current based on the start-of-flow current, the calibration-flow current, and the calibration-flow valve command; and
creating a valve calibration table based on the start-of-flow current and the maximum-flow current.

2. The method of claim 1, wherein determining the start-of-flow current includes:
setting a pump within the first hydraulic circuit to an initial displacement;
setting a pump within the second hydraulic circuit to an initial displacement;
setting the solenoid current to a predetermined current value;
increasing the solenoid current according to a current profile that includes a plurality of discrete current values;
for each current value, acquiring measurements from a pressure sensor coupled to the first hydraulic circuit;
comparing each pressure measurement to a predetermined pressure value; and
setting the start-of-flow current to the current value associated with the first measured pressure that exceeds the predetermined pressure value.

3. The method of claim 2, wherein the predetermined current value is about 400 mA, the current profile has a ramp rate of between about 25 mA/s and about 200 mA/s, and the predetermined pressure value is between about 200 kPa and about 1000 kPa.

4. The method of claim 1, wherein the hydraulic actuator is a hydraulic lift cylinder having a cross-sectional area and a length, wherein determining the first flow includes determining a first velocity of the hydraulic lift cylinder and then multiplying the first velocity with the area of the hydraulic lift cylinder, and wherein determining the second flow includes determining a second velocity of the hydraulic lift cylinder and then multiplying the second velocity with the area of the hydraulic lift cylinder.

5. The method of claim 4, wherein determining the first velocity and second velocities of the hydraulic lift cylinder includes measuring a time required for the hydraulic lift cylinder to pass through a distance, determining an increase in the length of the hydraulic cylinder based on the distance, and dividing the hydraulic cylinder length increase by the time.

6. The method of claim 5, wherein the distance is based on data received from a rotation sensor mechanically coupled to the hydraulic cylinder.

7. The method of claim 1, wherein determining the calibration-flow valve command associated with the flow difference includes searching a valve response table, stored in a memory, for a valve command associated with the flow difference.

8. The method of claim 7, wherein determining the maximum-flow current includes associating the start-of-flow current with a start-of-flow valve command of zero, associating the calibration-flow current with the calibration-flow valve command, associating the maximum-flow current with a maximum-flow valve command of one, and solving for the maximum-flow current by linearly extrapolating a line defined by the start-of-flow current and valve command values, and the calibration-flow current and valve command values.

9. The method of claim 1, wherein the valve response table includes flow and valve command data pairs, and creating the valve calibration table includes converting each flow and valve command data pair into a flow and current data pair.

10. The method of claim 9, wherein valve command data is converted into current data using a valve linearization table created from the start-of-flow current and valve command values, and the maximum-flow current and command values.

11. The method of claim 9, wherein valve command data is converted into current data using a formula based on the start-of-flow current and valve command values, and the maximum-flow current and command values.

12. A controller for a vehicle that includes a solenoid-controlled excess flow control valve that couples a steering hydraulic circuit to an implement hydraulic circuit with a lift control valve coupled to a lift cylinder, the controller comprising:
a memory; and
a processor, coupled to the memory and the first and second hydraulic circuits, the processor adapted to execute instructions stored in the memory to perform a method for calibrating the solenoid-controlled excess flow control valve, the instructions comprising:
determining a start-of-flow current at which hydraulic fluid begins to flow from the steering hydraulic circuit to the implement hydraulic circuit,
with the excess flow control valve closed, determining a first flow through the lift cylinder during operation thereof,
with the excess flow control valve partially open, determining a second flow through the lift cylinder during operation thereof,
determining a valve command, associated with the partially-open excess flow control valve, based on a flow difference between the first flow and the second flow and a valve response table stored in the memory,
determining a maximum-flow current based on the start-of-flow current, a current associated with the partially-open valve, and the valve command, and
creating a valve calibration table based on the start-of-flow current, the maximum-flow current and the valve response table.

13. The controller of claim 12, wherein determining a start-of-flow current includes:
setting a pump within the steering circuit to an initial displacement;
setting a pump within the implement hydraulic circuit to an initial displacement;
setting the solenoid current to a predetermined current value;
increasing the solenoid current according to a current profile that includes a plurality of discrete current values;
for each current value, acquiring measurements from a pressure sensor coupled to the steering hydraulic circuit;
comparing each pressure measurement to a predetermined pressure value; and
setting the start-of-flow current to the current value associated with the first measured pressure that exceeds the predetermined pressure value.

14. The controller of claim 13, wherein the predetermined current value is about 400 mA, the current profile has a ramp rate of between about 25 mA/s and about 200 mA/s, and the predetermined pressure value is between about 200 kPa and about 1000 kPa.

15. The controller of claim 12, wherein the hydraulic lift cylinder has a cross-sectional area and a length, wherein determining the first flow includes determining a first velocity of the hydraulic lift cylinder and then multiplying the first velocity with the area of the hydraulic lift cylinder, and wherein determining the second flow includes determining a second velocity of the hydraulic lift cylinder and then multiplying the second velocity with the area of the hydraulic lift cylinder.

16. The controller of claim 15, wherein determining the first velocity and second velocities of the hydraulic lift cylinder includes measuring a time required for the hydraulic lift cylinder to pass through a distance, determining an increase in the length of the hydraulic cylinder based on the distance, and dividing the hydraulic cylinder length increase by the time.

17. The controller of claim 16, wherein the distance is based on data received from a rotation sensor mechanically coupled to the hydraulic cylinder.

18. The controller of claim 12, wherein determining the maximum-flow current includes associating the start-of-flow current with a start-of-flow valve command of zero, associating the partially-open valve current with the partially-open valve command, associating the maximum-flow current with a maximum-flow valve command of one, and solving for the maximum-flow current by linearly extrapolating a line defined by the start-of-flow current and valve command values, and the partially-open valve current and valve command values.

19. The controller of claim 12, wherein the valve response table includes flow and valve command data pairs, and creating the valve calibration table includes converting each flow and valve command data pair into a flow and current data pair.

20. The controller of claim 19, wherein valve command data is converted into current data using a valve linearization table created from the start-of-flow current and valve command values, and the maximum-flow current and command values.

21. The controller of claim 19, wherein valve command data is converted into current data using a formula based on the start-of-flow current and valve command values, and the maximum-flow current and command values.

22. The method of claim 1, further comprising, after determining the first flow and before opening the valve, returning the hydraulic actuator to an initial position.

23. The method of claim 1, further comprising composing a valve linearization table, stored in a memory, with the valve calibration table to create a valve response table.
